(19) United States
(12) Patent Application Publication
(10) Pub. No.: US 2011/0063220 A1
(43) Pub. Date: Mar. 17, 2011

(54) INPUT DEVICE

(75) Inventor: Guang-Feng Ou, Shenzhen City (CN)

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/862,729

(22) Filed: Aug. 24, 2010

(30) Foreign Application Priority Data
Sep. 11, 2009 (CN) 200910306922.4

(51) Int. Cl. G06F 3/02; G06F 3/033

(52) U.S. Cl. 345/163

(57) ABSTRACT

An input device comprises a substrate, a mouse unit and a keyboard unit, wherein the switch unit is provided on a lateral side of the substrate, which activates the input device as the mouse unit or the keyboard unit. A cover is pivotally provided between the keyboard unit and the mouse unit, and when the input device is activated as a mouse unit, the cover can be closed for ease of handling. When the input device is activated as the keyboard, the cover can be opened for input. The keyboard unit comprises a right row selection key and several row selection keys to input different key values on a main key.

### BACKGROUND

1. Technical Field

The present application is related to an input device.

2. Description of Related Art

A keyboard and a mouse are frequently used input devices for a personal computer. However, a conventional keyboard occupies a lot of space on a work surface. Therefore, an input device is desired to overcome the limitations described.

### BRIEF DESCRIPTION OF THE DRAWINGS

FIG. 1 is a side view of an input device illustrated by one embodiment of the present application.

FIG. 2 is a block diagram showing functional connection of a switch unit, a mouse unit and a keyboard unit of the input device of FIG. 1.

FIG. 3 is a top view of a keyboard unit in FIG. 1, which shows an exemplary arrangement of the keyboard unit.

FIG. 4 is a top view of another embodied keyboard module of the present application.

FIG. 5 is a block diagram illustrating activation for the embodied keyboard units of the present application.

### DETAILED DESCRIPTION

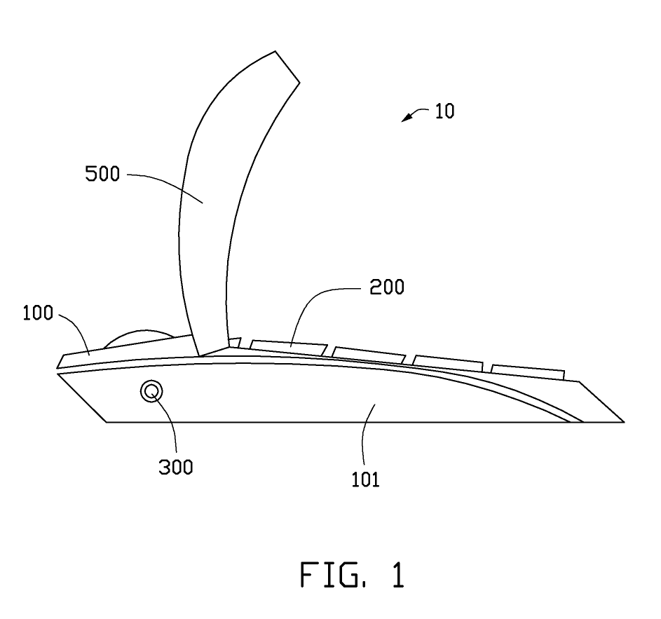

Referring to FIG. 1, an input device 10 of one embodiment of the present application comprises a substrate 101, a mouse unit 100, a keyboard unit 200, a switch unit 300 and a cover 500. The mouse unit 100 and the keyboard unit 200 are provided on top of the substrate 101, and the switch unit 300 is provided on a lateral side of the substrate 101. The cover 500 is pivotally positioned on the substrate 101, between the mouse unit 100 and the keyboard unit 200, and the edge shape of the cover 500 corresponds to the outer shape of the keyboard unit 200. The top of the cover 500 is shaped for ease of handling. When only the mouse unit 100 is needed, the cover 500 remains closed to cover the keyboard unit 200 for ease holding and preventing dust; and when the keyboard unit 100 is needed, the cover 500 can be opened.

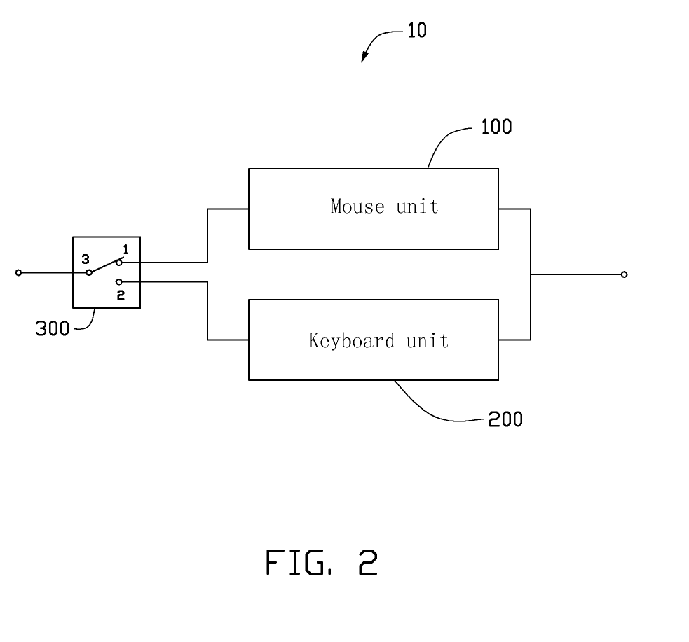

FIG. 2 is a block diagram showing functional connection of a switch unit, a mouse unit and a keyboard unit of the input device of one embodiment of the present application. The mouse unit 100 and the keyboard unit 200 are connected to the same transmission line connected to the computer for signal input. The switch unit 300 controls activation of the input device 10 as the mouse unit 100 or the keyboard unit 200.

The switch unit 300 is embodied as a single pole double throw (SPDT) switch, and provided on a lateral of the substrate 101. A first throw contact and a second throw contact of the switch unit 300 are connected to one end of the mouse unit 100 and one end of the keyboard unit 200, respectively. A third throw contact is connected to a power supply. The other end of the mouse unit 100 and the other end of the keyboard unit 200 are connected to the same transmission line. When the third throw contact of the switch unit 300 is connected to the first throw contact, the input device 10 is activated as a mouse, and the cover 500 can remain closed for ease of handling. When the third throw contact of the witch unit 300 is connected to the second throw contact, the input device 10 is activated as a keyboard, and the cover 500 can be opened for inputting.

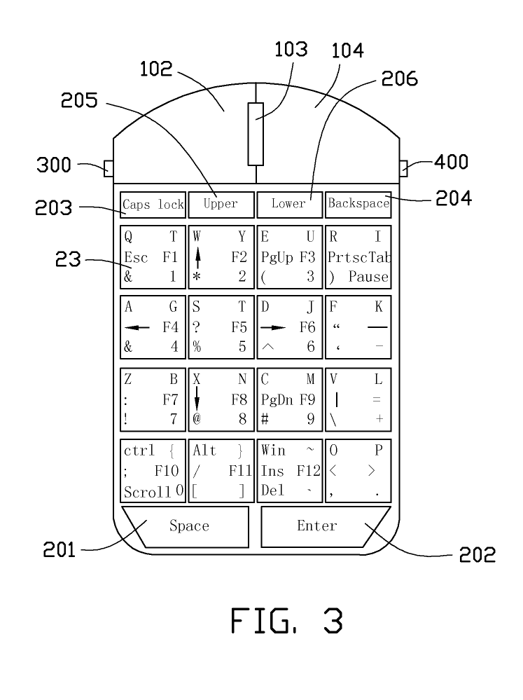

Referring to FIG. 3, the mouse unit keyboard unit 100 comprises a left mouse key 102, a central selection key 103, and a right mouse key 104. The left mouse key 102, the central selection key 103, and a right mouse key 104 are configured as a common mouse's functional keys.

The keyboard unit 200 comprises a capital key 203, a backspace key 204, an upper selection key 205, a lower selection key 206, a space key 201 and an enter key 202. The keyboard unit 200 also comprises several main keys 23.

Key values of the main key 23 comprise alphabets, numerals, punctuation marks, special characters, operation symbols, and function keys. Some uncommon key functions, such as Home, End, are omitted, and other commonly-used key values are integrated into 16 main keys, each of them comprising six key values. The six different key values are distributed in three horizontal rows, and each horizontal row comprises left and right key values. The keyboard unit 200 comprises three functional keys, including a right row selection key 400, an upper selection key (“Upper” key) 205 and a lower selection key (“Lower” key) 206. The right row selection key 400 is positioned on one lateral side of the substrate 101 opposite to the switch unit 300 and configured for input of the right key value of the main key 23. The left key value of the first row of the main key 23 is selected by directly depression of the main key 23. The left key value of the second row of the main key 23 is selected by depression of both the upper row selection key (“Upper” key) 205 and the main key 23 sequentially, and the left key value of the third row of the main key 23 is selected by depression of both of the lower row selection key 206 and the main key 23.

An exemplary input method for the key values of the main key 23 follows. For example, the left key value of the first horizontal row of the main key 23 is “Q”, the right key value of the first horizontal row of the main key 23 is “T”, the left key value of the second horizontal row of the main key 23 is “Esc”, the right key value of the second horizontal row of the main key 23 is “F1”, the left key value of the third horizontal row of the main key 23 is “&”, and the right key value of the third horizontal row of the main key 23 is “1”. If a “&” key value is to be input, “Lower” key 206, and main key 23 should be depressed sequentially. If a “F1” key value is to be input, the right row selection key 400, the “Upper” key 205 and the main key 23 should be depressed sequentially. If a “1” key value is to be input, the right row selection key 400, “Lower” key 206 and the main key 23 should be depressed sequentially. If a “Q” key value is to be input, the main key 23 should be directly depressed. If a “T” key value is to be input, the right row selection key 400 and the main key 23 should be depressed sequentially.

If a “q” key value is to be input, the capital key 203 and the main key 23 should be depressed sequentially. If a “t” key value is to be input, the capital key 203, the right row selection key 400 and the main key 23 should be depressed sequentially.

Once the right row selection key 400 has been depressed for inputting a right key value of the main key 23, depressing it again recovers the predetermined key value.

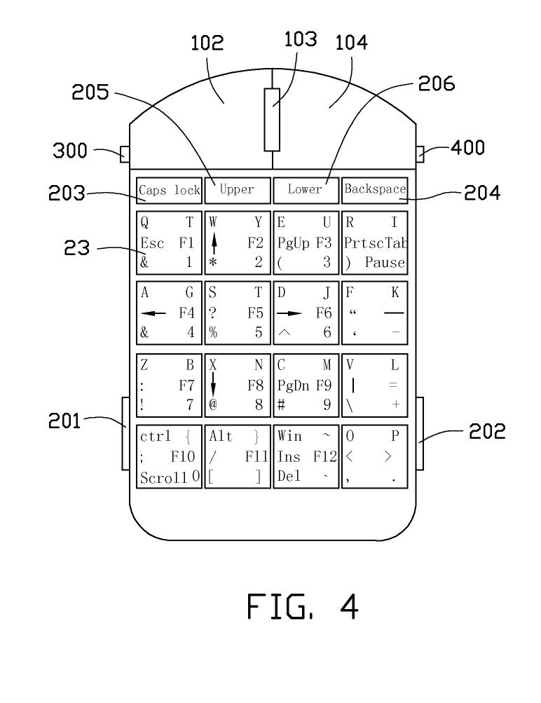

Referring to FIG. 4, another embodiment of the present application is shown, differing from FIG. 3 only in that space key 201 and enter key 203 are positioned laterally on the substrate 101.

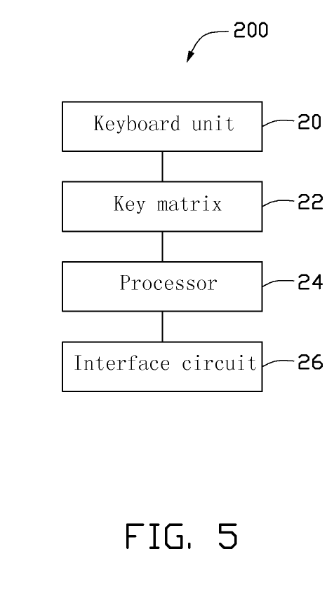

Referring to FIG. 5, the keyboard unit 200 comprises a key element 20, a key matrix 22, a processor 24 and an interface circuit 26. The key element 20 comprises circuits corresponding to different key values of the main key 23, each of which is normally open. A character table corresponding to the key values of the key element 20 is saved in a memory of the processor 24. When a key or a combination of keys is activated, the circuit of the key element 20 corresponding to the key or the combination of keys is closed. When the processor 24 detects the closed state of the circuit, the processor 24 confirms the key value corresponding to the key or the combination of keys in the character table, and the confirmed key value is transmitted to the computer. It is known in the art that different arrangement of the key value differing from the keyboard unit 200 can be programmed and saved in the character table of the memory of the processor 24.

The input device disclosed by the present application implements reduction of volume of conventional input devices for personal computers by integrating functions of a mouse and a keyboard in one.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An input device, comprising:
a substrate;
a mouse unit provided on the substrate;
a keyboard unit, provided on the substrate;
a switch unit, wherein the switch unit is configured for activating the mouse unit or the keyboard unit.

2. The input device as claimed in claim 1, further comprising a cover to cover the keyboard unit when the keyboard unit is not in use; the switch unit being mounted on a lateral side of the substrate.

3. The input device as claimed in claim 2, wherein a top of the cover is formed as a curved shape.

4. The input device as claimed in claim 2, wherein the keyboard unit comprises several main keys, each main key is configured for outputting several key values displayed in rows on the surface of the main key.

5. The input device as claimed in claim 4, wherein the keyboard unit further comprises several selection keys for selecting the key values of the main keys.

6. The input device as claimed in claim 4, wherein the keyboard unit further comprises a right row selection key for selecting the right side of key values distributed in each row.

7. The input device as claimed in claim 1, wherein the keyboard unit and the mouse unit are connected to a transmission line.

8. The input device as claimed in claim 1, wherein the switch unit is a single pole double throw switch comprising a first contact, a second contact and a third contact, wherein the third contact is connected to a power supply, the first contact is connected to the mouse unit, and the second contact is connected to the keyboard unit.

9. An input device, comprising:
a keyboard unit;
a keyboard electrically connected to the keyboard unit, which comprising several keys;
a key element electrically connected to the keyboard and the keyboard unit, which comprising circuits activating by different key values;
a processor electrically connected to the key element, the keyboard and the key element, saving a character table corresponding to the key values of the key element;
an interface circuit electrically connected to the processor;
wherein when a key or a combination of keys on the keyboard is activated, the circuit of the key element corresponding to the key or the combination of keys is closed; when the processor detects the closed state of the circuit, the key value corresponding to the key or the combination of keys is confirmed in the character table by the processor, and the confirmed key value is transmitted to a computer through the interface circuit.
